(19) United States
(12) Patent Application Publication
(10) Pub. No.: US 2009/0191303 A1
(43) Pub. Date: Jul. 30, 2009

(54) Mold Assembly for Manufacturing Blades of a Fan and the Method for Manufacturing the Same

(75) Inventors: HF Li, Dongguan (CN); Jack Cao, Kao-Chou City (CN)

Correspondence Address: GROSSMAN, TUCKER, PERREAULT & PFLEGER, PLLC, 55 SOUTH COMMERICAL STREET, MANCHESTER, NH, 03101, US

(73) Assignees: DELTA ELECTRONICS COMPONENTS (DONGGUAN) CO., LTD, Dong-Guan City (CN); DELTA ELECTRONICS, INC., Taoyuan Hsien (TW)

(21) Appl. No.: 12/333,646

(22) Filed: Dec. 12, 2008

(30) Foreign Application Priority Data
Jan. 25, 2008 (CN) 200810006926.6

(51) Int. Cl. B29C 45/40

(52) U.S. Cl. 425/556; 264/219

(57) ABSTRACT

A mold assembly for manufacturing the blades of a fan and the method for manufacturing the same are provided. The mold assembly comprises a lower blade mold, a modulating mold block and a positioning device, wherein the positioning device sustains between the lower blade mold and the modulating mold block to prevent the relative movement thereof. The modulating mold block is received in a central receiving space of the lower blade mold, and comprises at least one recess and at least one modulating element, wherein the at least one modulating element is correspondingly received in the recess to modulate the blades of the fan into optimal kinetic equilibrium after being formed.

This application claims priority to China Patent Application No. 200810006926.6 filed on Jan. 25, 2008, the disclosure of which is incorporated herein by reference in its entirety.

### CROSS-REFERENCES TO RELATED APPLICATIONS

Not applicable.

### BACKGROUND OF THE INVENTION

1. Field of the Invention

The present invention relates to a mold assembly for manufacturing blades of a fan; and more particularly, the present invention relates to a mold assembly for integrally manufacturing blades of a fan in optimal kinetic equilibrium.

2. Descriptions of the Related Art

With the rapid development of high-tech industries, various electronic products have become functionally more powerful. Accordingly, the power consumption of such products is also increasing, which increases the demands on heat dissipation. Presently, the rotational speed of common cooling fans is required to reach more than 3000 rpm and even up to above 7000 rpm when operating at high power. At such a high rotational speed, the fan blades should be kinetically modulated appropriately to prevent dramatic vibration and noises originating from the fans during operation. This not only helps to improve the quality of the electronic products, but may prolong the service life of the fan itself.

Unfortunately, the primary method used to achieve the kinetic equilibrium of fan blades in the prior art is to use additional counterweights or counterbalance earth or to drill holes in the mold assembly for manufacturing the blades or in the yielded products. However, this method is time consuming, costly and results in inconsistent quality among the products. Other methods for reaching kinetic equilibrium, including hollowing plastic blades or adding a steel housing outside the fan blades, are also time consuming, costly and involve complex manufacturing processes.

In view of this, it is highly desirable in the field to provide a cost-effective mold assembly for modulating the kinetic equilibrium of the blades of a fan rapidly.

### SUMMARY OF THE INVENTION

One objective of this invention is to provide a mold assembly for manufacturing the blades of a fan. The mold assembly is able to modulate the kinetic equilibrium of the blades easily within a short time and at a low cost to overcome the aforementioned drawbacks of conventional kinetic equilibrium modulating methods.

The mold assembly of this invention comprises a lower blade mold, a modulating mold block and a positioning device. The positioning device is adapted to sustain between the lower blade mold and the modulating mold block to prevent relative movement of the lower blade mold and the modulating mold block. The lower blade mold defines a central receiving space for receiving the modulating mold block. The modulating mold block comprises at least one recess and at least one modulating element. The at least one recess extends downwards from a top surface of the modulating mold block, and at least one modulating element is received in the at least one recess correspondingly to modulate distribution of the material injected into the mold assembly. By adjusting the orientations, locations, amounts, sizes and shapes of the at least one recess and the at least one modulating element in the modulating mold block, alterations can be made to the orientation of the material for modulating the kinetic equilibrium of the blades of a fan, mass of the kinetic balancing material and the embedded pattern formed by the kinetic balancing material in the blades of the fan. Therefore, by using the mold assembly, a better or optimal kinetic equilibrium of the blades of the fan can be accomplished within a short time and at a low cost.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a cross-sectional side view of a first embodiment of a mold assembly of this invention;

FIG. 2 is a top view of the first embodiment of the mold assembly of this invention;

FIG. 3 is a perspective view of the first embodiment of the mold assembly of this invention;

FIG. 4 is schematic perspective view of a modulating mold block in combination with a positioning device of this invention;

FIG. 5 is a schematic top view of a modulating mold block of a second embodiment of this invention;

FIG. 6 is a schematic top view of a modulating mold block of a third embodiment of this invention;

FIG. 7 is a schematic top view of a modulating mold block of a fourth embodiment of this invention;

FIG. 8 is a schematic top view of a modulating mold block of a fifth embodiment of this invention; and

FIG. 9 is a flow diagram of a process for manufacturing a mold assembly of this invention.

### DESCRIPTION OF THE PREFERRED EMBODIMENT

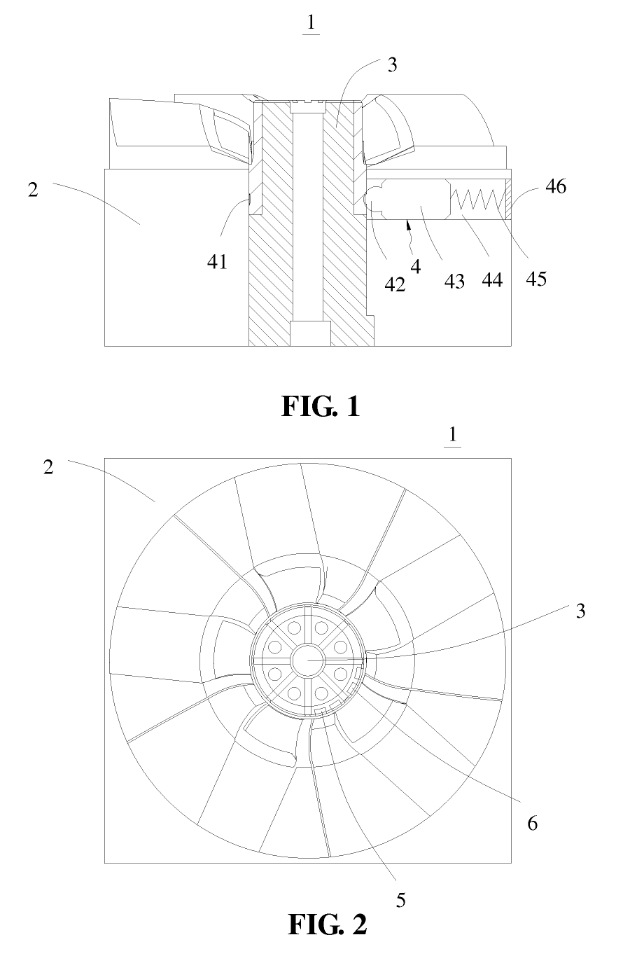

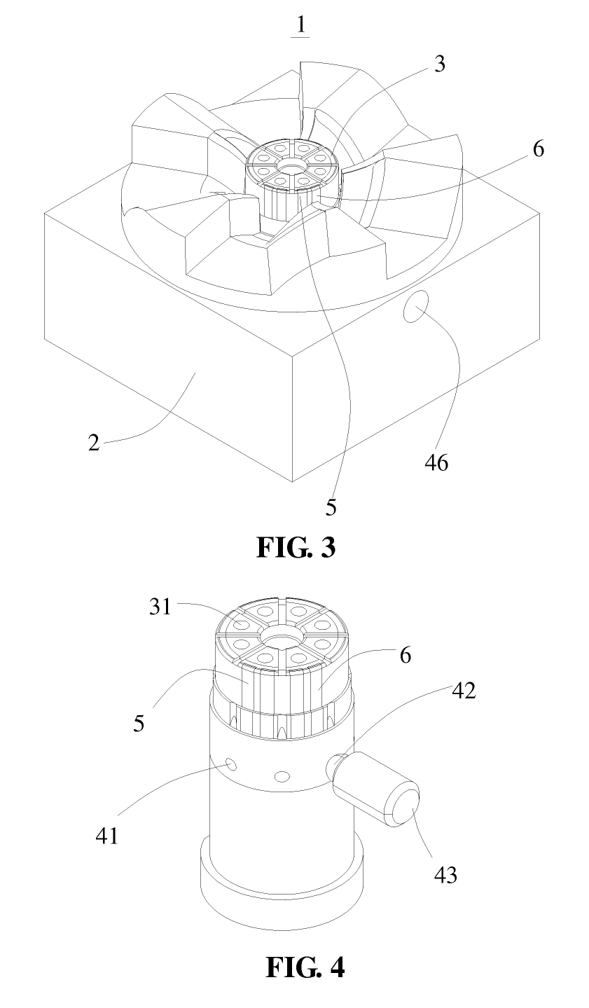

As shown in FIGS. 1, 2 and 3, a mold assembly 1 for manufacturing blades of a fan according to this invention comprises a lower blade mold 2, a modulating mold block 3 and a positioning device 4. By modulating the distribution of some parts of the modulating mold block 3, the distribution of the material to be injected during the production of the blades can get modulated to achieve a better or optimal kinetic equilibrium of the yielded blades. The lower blade mold 2 is assembled together with an upper blade mold (not shown) to form a complete fan blade mold for manufacturing blades of a fan. The lower blade mold 2 may define a central receiving space for receiving the modulating mold block 3.

Also shown in FIGS. 1, 3 and 4, to fix the modulating mold block 3 to the lower blade mold 2, a positioning device 4 sustaining between the lower blade mold 2 and the modulating mold block 3 is provided in this invention to prevent the relative movement of the modulating mold block 3 and the lower blade mold 2. Preferably, the positioning device 4 should comprise at least one positioning concave 41 disposed on an outer surface of the modulating mold block 3, while the lower blade mold 2 comprises at least one positioning element to elastically sustain the at least one positioning concave 41. More preferably, the positioning device 4 comprises a plurality of positioning concaves 41 and a plurality of positioning elements disposed around a periphery of the modulating mold block 3. Each of the positioning elements is disposed in one of a plurality of inner traverse blind holes 44, and comprises a positioning ball 42, a rod 43 and an elastic element 45. The rod 43 has two opposite ends. The elastic element 45 is disposed between one end of the rod 43 and a bottom 46 of the corresponding blind hole, and the positioning ball 42 is disposed at the other end of the rod 43. The positioning ball 42 protrudes from the corresponding blind hole 44 to be embedded into the positioning concave 41. In this way, the modulating mold block 3 and the lower blade mold 2 are assembled into a complete mold without the relative rotation or displacement therebetween.

A first embodiment of this invention is depicted in FIG. 4. The modulating mold block 3 comprises at least one ejector hole 31, at least one recess 5 and at least one modulating element 6. The ejector hole 31 extends downwards from the top surface of the modulating mold block 3 for ejection upon the completion of the blades. The recess 5 also extends downwards from the top surface of the modulating mold block 3, and the modulating element 6 is correspondingly received in the recess 5. To achieve more modulating flexibility, the modulating mold block 3 of this embodiment are formed in advance with a plurality of recesses 5 and a plurality of modulating elements 6 correspondingly disposed in at least some of the recesses 5. Therefore, an optimal kinetic equilibrium can be achieved by modulating the amount, sizes and locations of the plurality of modulating elements 6. Then, mass production for the fan blades can be performed under the same distribution conditions of the preset modulating elements 6, yielding products with optimal kinetic equilibrium. In other words, the mold assembly 1 of this invention allows the modulation of distribution of the material injected into the mold assembly by use of the modulating elements 6 disposed in different recesses 5. In this way, the mass distribution of the yielded fan blades may be appropriately modulated to achieve a desired kinetic equilibrium. Of course, since the modulating elements 6 for modulating the material injected into the mold assembly 1 have various sizes or length, the modulating elements 6 may either protrude from or be recessed into an external surface of the modulating mold block 3.

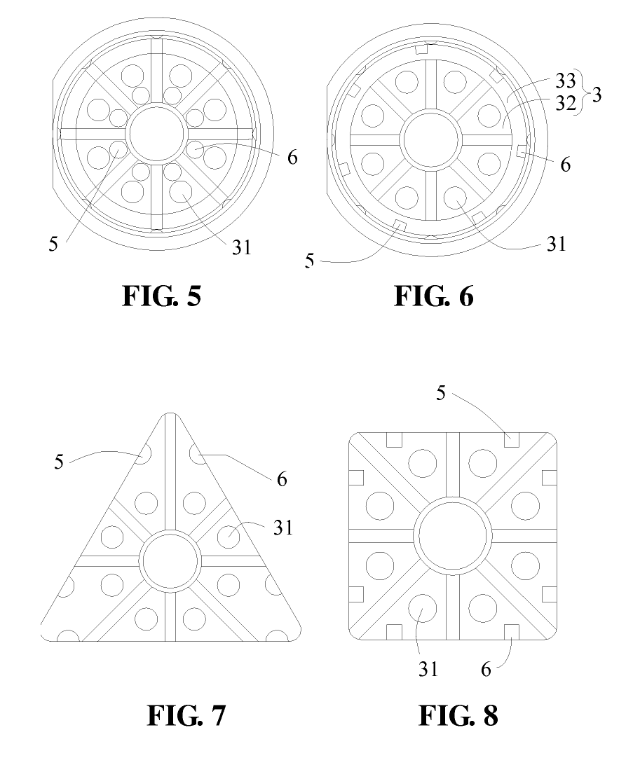

In the first embodiment of this invention, the plurality of recesses 5 of this invention are disposed on an outer surface of the modulating mold block 3 and extending downwards from the top surface of the modulating mold block 3. Hence, in the blades produced by the mold assembly 1 in combination with the modulating elements 6, strips of kinetic balancing material will be formed on an inner surface of a sidewall of an inner hub. However, the recesses 5 may also be disposed at other locations, and the objective of this invention may also be accomplished by disposing the modulating elements 6 into corresponding recesses 5. For example, as shown in FIG. 5, the recesses 5 in the second embodiment of this invention are not disposed on the outer surface of the modulating mold block 3 and only extend downwards from the top surface of the modulating mold block 3. Accordingly, in the fan blades produced by the mold assembly 1 of the second embodiment in combination with the modulating elements 6, the kinetic balancing material will be formed on an inner side of a top wall of the inner hubs of the fan blades.

The modulating mold block 3 of this invention also consists of a number of elements. For example, in the third embodiment of this invention depicted in FIG. 6, the modulating mold block 3 comprises a body 32 and an enclosure 33 enclosing an outside of the body 32. The recesses 5 extend downwards from a top surface of the enclosure 32. The ejector holes 31 are disposed on the body 32. This disposition allows the easy and rapid adjustment of the amounts, sizes, arrangement and other parameters of the recesses 5 and the modulating elements 6 disposed on the enclosure 33 by simply replacing the enclosure 33.

Furthermore, the modulating mold block 3 of this invention is not just limited to a cylindrical shape depicted in the drawings of the above embodiment, but may also be shaped into a prism such as a triangular prism (referring to FIG. 7) or a rectangular prism (referring to FIG. 8), all of which may accomplish the objective of kinetic equilibrium of fan blades. Therefore, those of ordinary skill in the art may readily utilize various other shapes or arrangements of the modulating mold blocks, recesses and modulating elements to form a mold assembly that can integrally manufacture a product, and all these equivalent modifications will still fall within the scope of the claims of this invention.

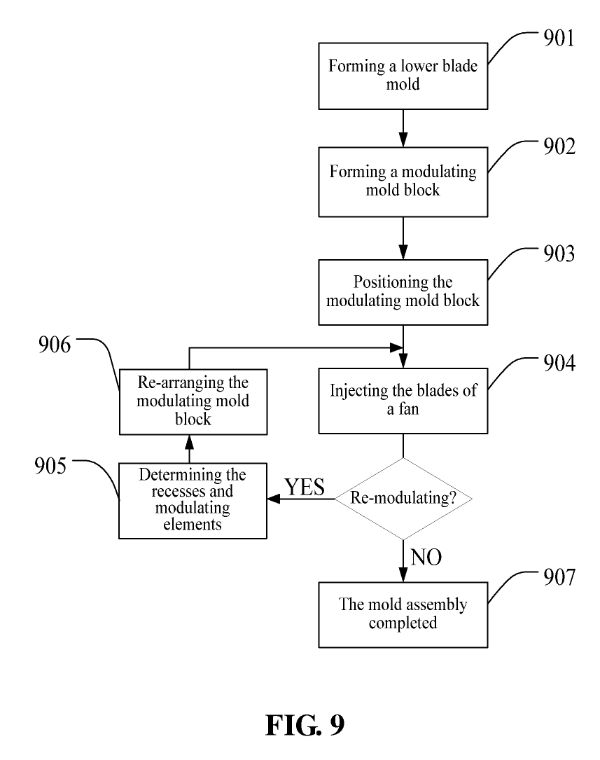

A flow diagram of a method for assembling and manufacturing a mold assembly for modulating the kinetic equilibrium of fan blades of this invention is depicted in FIG. 9. Initially in step 901, a lower blade mold which defines a central receiving space is formed. In step 902, a modulating mold block is formed and received in the central receiving space. The modulating mold block comprises at least one recess and at least one modulating element. The at least one recess extends downwards from a top surface of the modulating mold block, and the at least one modulating element is received correspondingly in the at least one recess to modulate the distribution of the material injected in the mold assembly. In step 903, a positioning device sustains between the lower blade mold and the modulating mold block to prevent relative movement therebetween. In step 904, a first fan blade product is injection molded in the assembled mold assembly and is tested for the kinetic equilibrium conditions to determine whether to re-modulate the arrangement of the recesses and modulating elements. If so, step 905 is executed; otherwise, step 907 is executed. In step 905, the amounts and locations of the recesses and modulating elements are determined according to the test results. In step 906, the modulating mold block is re-modulated according to the determined amounts and locations, and then steps 904 and 905 are repeated until the kinetic equilibrium is achieved in the yielded fan blades. Then, the process is ended in step 907. Through the above steps, the setup of the mold assembly is completed, so fan blades in optimal kinetic equilibrium can be manufactured in mass production.

According to the mold assembly of this invention and the manufacturing method thereof, by adjusting the amount, orientation, shape and volume of the modulating elements in the modulating mold block, alterations can be made to the orientation, mass and the embedded pattern of the material for modulating the kinetic equilibrium in the fan blades. Furthermore, the mold assembly of this invention is able to modulate the kinetic equilibrium in an angular range from 0° to 360°, and the modulated mass can be freely modulated. The resulting embedded structure may further be of any shape. For example, a cylindrical shape, a spherical shape, a cuboidal shape, a semi-cylindrical shape or even a triangular prism may be appropriate. Therefore, the mold assembly of this invention is adapted to modulate a better or optimal kinetic equilibrium of the fan blades in an accurate and easy way, within a short time and at a low cost, which means that the kinetic equilibrium methods for conventional molds of the prior art have been improved.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mold assembly for manufacturing blades of a fan, wherein the blades are modulated in kinetic equilibrium, the mold assembly comprising:
a lower blade mold defining a central receiving space;
a modulating mold block, fitted to and received in the central receiving space, the modulating mold block comprising:
at least one recess extending downward from a top surface of the modulating mold block; and
at least one modulating element received in the at least one recess correspondingly; and
a positioning device sustaining between the lower blade mold and the modulating mold block to prevent the lower blade mold and the modulating mold block from a relative movement.

2. The mold assembly as claimed in claim 1, wherein the modulating element is outwardly protruded from an external surface of the modulating mold block.

3. The mold assembly as claimed in claim 1, wherein the modulating element is recessed into an external surface of the modulating mold block.

4. The mold assembly as claimed in claim 1, wherein the modulating mold block comprises a plurality of recesses, and a plurality of modulating elements, which are correspondingly disposed into at least one portion of the plurality of recesses.

5. The mold assembly as claimed in claim 1, wherein the modulating mold block further comprises at least one ejector hole extending downward from the top surface.

6. The mold assembly as claimed in claim 1, wherein the modulating block comprises a body and an enclosure enclosing an outside of the body, and the at least one recess extends downward from a top surface of the enclosure.

7. The mold assembly as claimed in claim 1, wherein the positioning device comprises at least one positioning concave and the lower blade mold comprises at least one positioning element, elastically sustaining the at least one positioning concave.

8. The mold assembly as claimed in claim 7, wherein the positioning device comprises a plurality of positioning concaves, and the lower blade mold comprises a plurality of positioning elements and a plurality of inner transverse blind holes, each of the positioning elements being disposed in one of the inner transverse blind holes and comprising:
a rod having two opposite ends;
an elastic element elastically sustaining between a bottom of the corresponding blind hole and one end of the rod, wherein the other end of the rod is adapted to be embedded into the corresponding positioning concave.

9. The mold assembly as claimed in claim 8, wherein each of the positioning elements further comprises a positioning ball, protruding from the corresponding blind hole to embed into the positioning concave.

10. The mold assembly as claimed in claim 1, wherein the modulating mold block is a cylinder.

11. The mold assembly as claimed in claim 1, wherein the modulating mold block is a prism.

12. The mold assembly as claimed in claim 11, wherein the prism is a triangular prism

13. The mold assembly as claimed in claim 11, wherein the prism is a rectangular prism

14. A method for producing a mold assembly for manufacturing blades of a fan, comprising the steps of:
(a) forming a central receiving space on a lower blade mold;
(b) fitting a modulating mold block to be received in the central receiving space, the modulating mold block comprising:
at least one recess extending downward from a top surface of the modulating mold block; and
at least one modulating element received in the at least one recess correspondingly;
(c) preventing the lower blade mold and the modulating mold block from constituting a relative movement by using a positioning device sustaining therebetween;
(d) injecting a first blade product of the fan and testing the kinetic equilibrium thereof;
(e) determining amounts and locations of the at least one recess and the at least one modulating element that the modulating mold block needs to include; and
(f) repeating the step (b) and the step (c) according to the determined amounts and locations.
